(19) United States
(12) Patent Application Publication
(10) Pub. No.: US 2010/0161209 A1
(43) Pub. Date: Jun. 24, 2010

(54) Routing a User to a Parked Vehicle

(75) Inventor: Pedram Vaghefinazari, Encino, CA (US)

Correspondence Address: Capitol City TechLaw, PLLC, 113 S. Columbus St., Suite 302, Alexandria, VA, 22314, US

(73) Assignee: HONDA MOTOR CO., LTD., Tokyo (JP)

(21) Appl. No.: 12/340,086

(22) Filed: Dec. 19, 2008

(51) Int. Cl. G01C 21/00

(52) U.S. Cl. 701/201

(57) ABSTRACT

A method and a system are provided for directing a user to a vehicle. A user may make a request, from a portable device, to find a vehicle. Respective locations of the vehicle and the portable device may be obtained. Walking directions to the vehicle may be determined based on the obtained respective locations. Based on the walking directions, a walking distance from the location of the portable device to the vehicle may be determined. When the walking distance is less than or equal to a predetermined distance, a near indication may be provided from the vehicle. The near indication may include a visual indication and/or an audio indication. In some embodiments, a current location of the portable device may be obtained periodically and updated walking directions may be presented by the portable device. The presented walking directions may include text, a map, or generated speech.

### BACKGROUND

1. Field of the Invention

The present teachings relate to systems or methods directed to providing directions to a user to find a parked vehicle. Such methods may employ tracking of a portable device in possession of the user and providing the user with walking directions to the parked vehicle via the portable device.

2. Discussion of the Related Art

One known technique relating to a vehicle locating system, transmits a location signal, via a transmitter within the vehicle, to a handheld device including a receiver and a direction indicator visible on the handheld device. The direction indicator is configured to point towards the transmitter within the vehicle in response to transmission of the location signal.

Other known examples relate to navigation systems which provide walking directions to a desired destination. The walking directions may be available in various formats, such as, displayed text, displayed maps, or a printout on a sheet of paper. The walking directions may be transferred to a portable electronic device that a user can carry. The transferred walking directions may be static text or maps, and may include data identifying a location of a parked vehicle of a user and information about road segments in the vicinity of the parked vehicle and the desired destination. The portable device may include a positioning system, which may display a position of the user and may show a shortest possible walking route back to the parked vehicle.

Another known example relates to a system for locating a parked vehicle. Prior to a driver leading a vicinity of a parked vehicle, a handheld apparatus may be automatically engaged to retrieve global positioning system (GPS) location coordinates of the parked vehicle from GPS satellites. The location coordinates of the parked vehicle may be stored in a memory of the handheld apparatus. When the driver wishes to locate the parked vehicle, the handheld apparatus may retrieve a current location of the driver. Using the current location of the driver and the stored location coordinates of the parked vehicle, the handheld apparatus may calculate a shortest course between the driver and the parked vehicle. The course may be presented on a visual display by way of a “floating” directional arrow.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

In a first embodiment, a system and a method are provided for helping a user find a vehicle. A user carrying a portable device may make a request to find a vehicle. Locations of the vehicle and the portable device may be obtained and walking directions from the location of the portable device to the vehicle may be determined. A walking distance between the location of the portable device and the vehicle may be determined based on the walking directions. When the walking distance is determined to be less than or equal to a predetermined distance, a near indication may automatically be provided from the vehicle. The near indication may include an audio indication and/or a visual indication. When the walking distance is determined not to be less than or equal to the predetermined distance, the walking directions may be presented to the user via the portable device. The walking directions may be presented as displayed text, as a displayed map, or as generated speech.

In a second embodiment, a location of the portable device may be obtained periodically, as long as the user has not terminated permission, or authorization, to track the location of the portable device. Thus, the location of the portable device may be tracked and updated walking directions may be presented to the user via the portable device.

Various portions of the method may be performed by a number of components of the system, including, but not limited to, a device within the vehicle, the portable device, equipment in a call center, and a remotely located processor. In variations of the embodiments, the various portions of the method may be performed by others of the components of the system.

### BRIEF DESCRIPTION OF THE DRAWINGS

In order to describe the manner in which the above-recited and other advantages and features can be obtained, a more particular description is described below and will be rendered by reference to specific embodiments thereof which are illustrated in the appended drawings. Understanding that these drawings depict only typical embodiments and are not therefore to be considered to be limiting of its scope, implementations will be described and explained with additional specificity and detail through the use of the accompanying drawings.

FIG. 1 is a functional block diagram of a first operating environment for various embodiments.

FIG. 2 is a functional block diagram of a second operating environment for other embodiments.

FIGS. 3-5 are functional block diagrams of exemplary processing devices which may implement a portable device, a remotely located processing device, and a device within a vehicle, respectively.

FIGS. 6-7 are flowcharts illustrating an exemplary process which may be performed in some embodiments.

FIGS. 8-9 are flowcharts illustrating another exemplary process which may be performed in other embodiments.

### DETAILED DESCRIPTION

Overview

In a first embodiment, a system and a method may provide a user with walking instructions to a parked vehicle. The user may select a “find car” option from a menu presented on a portable device, which may be a handheld device. As a result of selecting the “find car” option, a signal may be transmitted to a device, having a receiver, within the vehicle to cause an audio indication and/or a visual indication to be provided from the vehicle. In some embodiments, the audio indication may include honking of a horn and the visual indication may include flashing of lights. In other embodiments, a different audio indication and/or visual indication may be provided from the vehicle.

The user may then request walking directions to the vehicle. As a result, a location of the portable device may be obtained and a location of the vehicle may be obtained. Walking directions, a direct distance, and a walking distance from the location of the portable device to the location of the vehicle may then be determined. The walking directions may be displayed on a display screen of the portable device.

If the walking distance or the direct distance is less than or equal to the predetermined distance, a signal may be transmitted to the device, within the vehicle, to cause a near indication to be provided from the vehicle. In some embodiments, the near indication may include the audio indication and/or the visual indication.

A second embodiment may be similar to the first embodiment. However, as long as the user has not withdrawn or terminated permission, or authorization, to track the location of the portable device, the location of the portable device may be periodically obtained and walking directions to the vehicle may be determined. If the walking distance or the direct distance is determined not to be greater than a predetermined distance, then a signal may be transmitted to the device within the vehicle to cause a near indication to be provided from the vehicle. The near indication may include an audio indication and/or a visual indication.

A determination may be made regarding whether a major change in the walking directions occurs. In some embodiments, a major change in walking directions may occur when the user carrying the portable device strays from the walking directions. For example, a major change may occur when the portable device is determined to be on a street not included in the walking directions.

If a major change in the directions occurs, then the user may be provided with new walking directions (for example, the new walking directions may include a recalculated route from a last known location of the portable device).

Exemplary Operating Environments

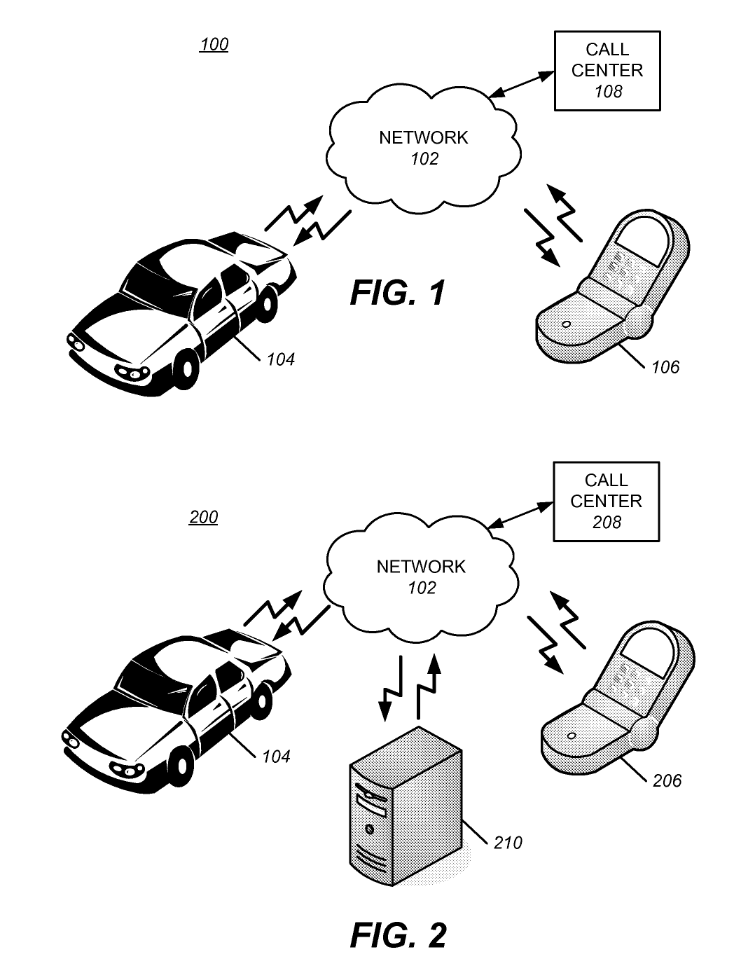

FIG. 1 illustrates an exemplary operating environment 100 for some embodiments. An exemplary operating environment 100 may include a network 102, a vehicle 104, a portable device 106, and a call center 108.

Network 102 may be a combination of networks, such as, for example, the Internet, a cellular communication network, a public switched telecommunication network (PSTN), as well as other types of networks.

Vehicle 104 may include a device capable of communicating with network 102 and providing an audio indication and/or a visual indication from vehicle 104 upon receiving a signal from portable device 106.

Portable device 106 may include a display and a communication interface. The display may provide walking directions in a textual form and/or a graphical form, such as, for example, a map. Portable device 106 may be a handheld device and may include a wireless communication device, such as, for example, a cellular telephone, as well as a navigation system. In some embodiments, the navigation system may communicate with a global positioning system (GPS) satellite.

Call center 108 may include personnel and processing devices for providing services to a user, such as, for example, a user of portable device 106 who may request a “find car” service for locating a parked vehicle.

FIG. 2 illustrates an exemplary operating environment 200 for other embodiments. Exemplary operating environment 200 may include network 102, vehicle 104, a portable device 206, a call center 208, and a processing device 210, such as, for example, a server or other processing device connected to network 202.

Portable device 206 may include a display and a communication interface. The display may provide walking directions in a textual form or a graphical form, such as, for example, a map. Portable device 206 may be a handheld device and may include a wireless communication device, such as, for example, a cellular telephone, or other device.

Call center 208 may include personnel and processing devices for providing services to a user, such as, for example, a user of portable device 206 who may request a “find car” service for locating a parked vehicle of a user.

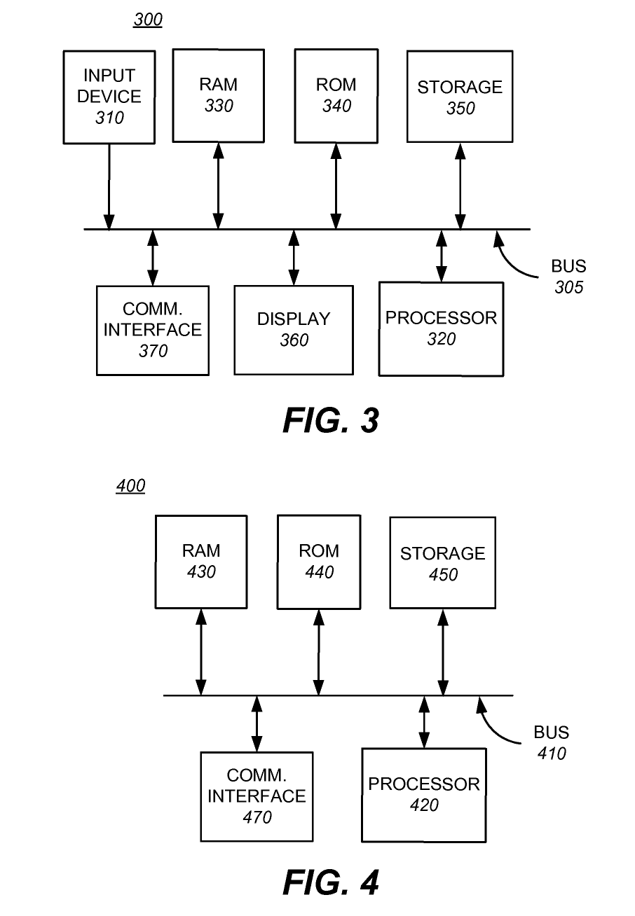

FIG. 3 is a functional block diagram of a processing device 300, which may implement portable device 106 or portable device 206. Processing device 300 may include input device 310, processor 320, random access memory (RAM) 330, read only memory (ROM) 340, storage 350, a display 360, a communication interface 370, and a bus 305 or other interface for permitting the aforementioned components to communicate with one another.

Input device 310 may include hard buttons, soft buttons, a touchscreen, a microphone, or other device for providing input. Processor 320 may include at least one conventional processor or microprocessor that interprets and executes instructions. Memory may include random access memory (RAM), read only memory (ROM), another type of storage, or any combination thereof. RAM 330 may include a dynamic storage device for storing information and instructions for execution by processor 320. RAM 330 may also store temporary variables or other intermediate information used during execution of instructions by processor 320. ROM 340 may include a conventional ROM device or another type of static storage device that stores static information and instructions for processor 320. Storage device 350 may include a hard disk and a corresponding drive, or other type of storage device for storing information including, but not limited to, a database and/or instructions for processor 320. Communication interface 370 may include a transceiver, or other device(s) for permitting processing device 300 to communicate via a network wirelessly.

In one implementation, processing device 300 may include a navigational database in storage 350 and navigational software in RAM 330, ROM 340, and/or storage 350. In some implementations, communication interface 370 may communicate with a GPS satellite for determining a location of processing device 300, and may communicate with a device within the vehicle to obtain a location of the vehicle. In another implementation, communication interface 370 may scan signals from wireless fidelity (WiFi) access points, GPS satellites, and cellular towers. The navigational database may include information regarding a unique signature of each WiFi access point, respective cell IDs of nearby towers and/or respective GPS satellites. The navigational software may use information in the navigational database to precisely locate processing device 300.

A system which scans an area for signals from Wi-Fi access points, GPS satellites and cellular towers and uses a unique signature of the scanned signals to arrive at a precise location is available from Skyhook Wireless of Boston, Mass.

In a third implementation, processing device 300 may communicate with a second processing device, such as, for example, processing device 210, which may provide processing device 300 with location information based on, for example, unique signatures of scanned wireless fidelity (Wi-Fi) access points, GPS satellites, and cellular towers reported by processing device 300.

FIG. 4 is a functional block diagram of a processing device 400, which may implement processing device 210 of FIG. 2. Processing device 400 may include a processor 420, a RAM 430, a ROM 440, storage 450, a communication interface 470, and a bus 410 or other interface for connecting the aforementioned components of processing device 400.

Processor 420 may include at least one conventional processor or microprocessor that interprets and executes instructions. Memory may include random access memory (RAM), read only memory (ROM), another type of storage, or any combination thereof. RAM 430 may include a dynamic storage device for storing information and instructions for execution by processor 420. RAM 430 may also store temporary variables or other intermediate information used during execution of instructions by processor 420. ROM 440 may include a conventional ROM device or another type of static storage device that stores static information and instructions for processor 420. Storage device 450 may include a hard disk and a corresponding drive, or other type of storage device for storing information including, but not limited to, a database and/or instructions for processor 420. Communication interface 470 may include a transceiver, or other device(s) for permit processing device 300 to communicate wirelessly or wired via a network.

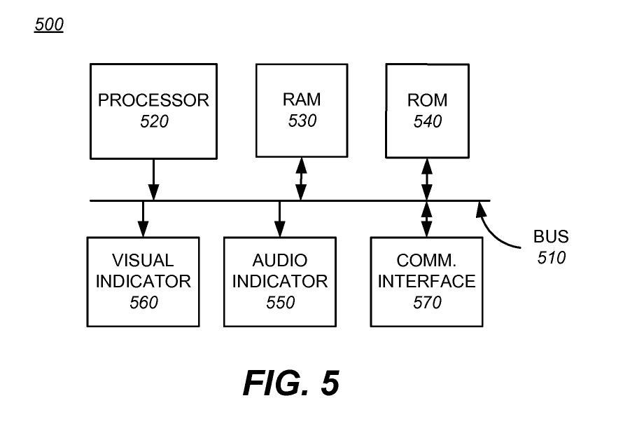

FIG. 5 is a functional block diagram of a device 500 included within a vehicle. Device of 500 may include a processor 520, a RAM 530, a ROM 540, a visual indicator 560, an audio indicator 550, a communication interface 570, and a bus 510 or other interface for connecting the aforementioned components of device 500.

Processor 520 may include at least one conventional processor or microprocessor that interprets and executes instructions. Memory may include random access memory (RAM), read only memory (ROM), or another type of storage. RAM 530 may include a dynamic storage device for storing information and instructions for execution by processor 520. RAM 530 may also store temporary variables or other intermediate information used during execution of instructions by processor 520. ROM 540 may include a conventional ROM device or another type of static storage device that stores static information and instructions for processor 420. Visual indicator 560 may include vehicle lights, such as, for example, headlights, headlights and tail lights, or other lights. Audio indicator 550 may include a horn, a siren, or other sound producing device. Communication interface 570 may include a transceiver, or other device(s) for permitting processing device 300 to communicate wirelessly via a network.

Exemplary Processes

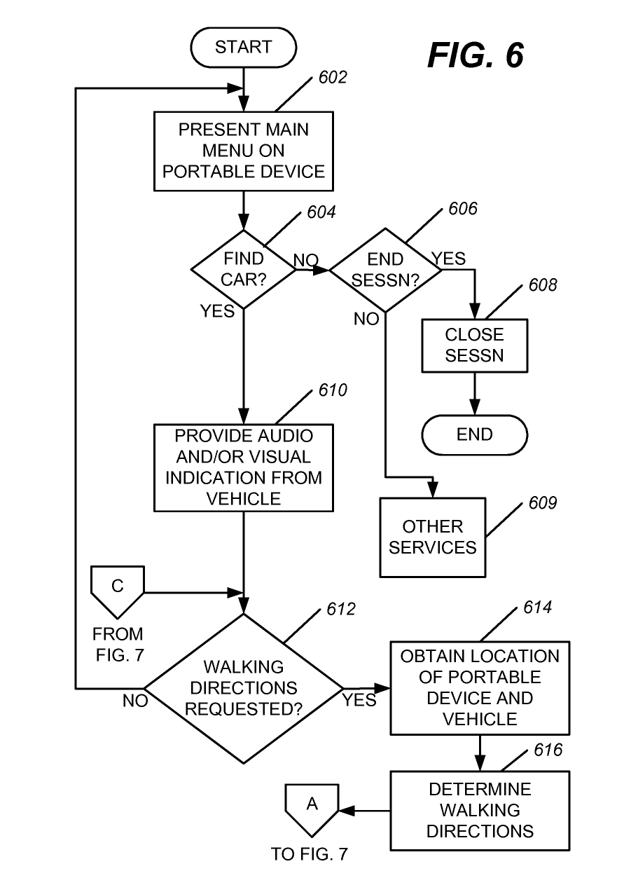

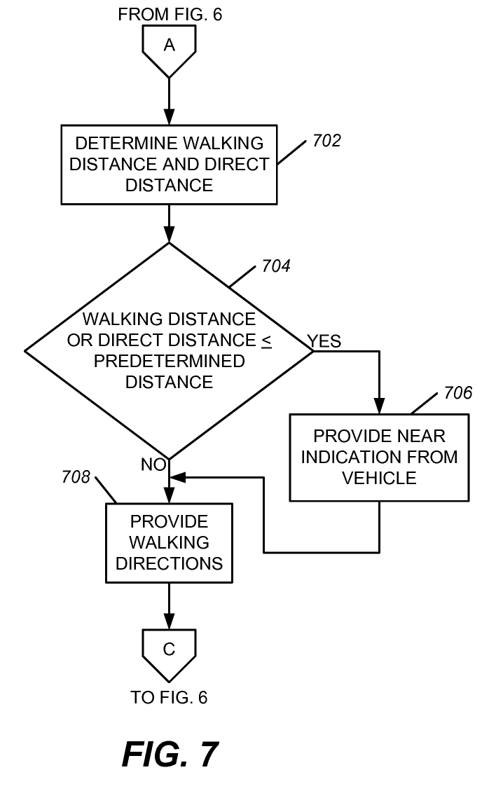

FIGS. 6 and 7 are flowcharts illustrating an exemplary process which may be performed in various embodiments. The process may begin with a main menu being presented on a display of a portable device (act 602). In some embodiments, the portable device may include a cellular phone, which a user may use to call a call center. In such embodiments, after calling the call center, via the portable device, and after the user is authenticated, the main menu may be presented on the display of the portable device. Alternatively, the main menu may be provided verbally to the user via a speaker of the portable device, including, but not limited to, a cellular phone speaker. The main menu may include a number of services that the user may select, including a “find car” service for helping the user find a parked vehicle.

Next, a determination may be made regarding whether the user has selected a “find car” service (act 604). The user may select a service by speaking a command into a microphone of a cellular phone included in the portable device, tapping a representation of the service on a touch screen display of the portable device, pressing a hard button or touching a soft button of the portable device, or via other selection methods.

If the user did not select the “find car” service”, then a determination may be made regarding whether the user indicated a desire to end a current session (act 606). If the user indicated a desire to end the current session, then the session may be ended (act 608) and the process may be completed.

If, during act 606, a determination is made that the user did not indicate a desire to end the current session, then an assumption may be made that the user selected a service other than the “find car” service and the other service may be provided to the user (act 609).

If, during act 604, a determination is made that the user selected the “find car” service, then an audio indication and/or a visual indication may be provided from the vehicle for a preset period of time (act 610), such as, for example, 10 seconds or another period of time. The audio indication may include, but not be limited to, a horn and the visual indication may include, but not be limited to, lights, such as, for example, headlights, headlights and tail lights, or other lights. In embodiments including a call center, a signal may be sent from the call center, via a network, to a device within the vehicle. Upon receiving the signal, the device within the vehicle may cause the audio indication and/or the visual indication to be provided. In other embodiments, the portable device may send the signal, via a network, to the device within the vehicle.

Next, a determination may be made regarding whether the user requests walking directions to the vehicle (act 612). The user may request walking directions by selecting a “request walking directions” menu item from a displayed menu, by pressing a hard button or touching a soft button, by speaking a command into a microphone of a cellular phone included in the portable device, or by other methods.

A location of the portable device and a location of the vehicle may then be obtained (act 614). In embodiments which include a call center, a request location signal may be sent to the device within the vehicle and to the portable device. The device within the vehicle may include a navigation system, which communicates with a GPS satellite. The navigation system may have tracked the location of the vehicle, until the vehicle is parked, and may have stored the location of the vehicle in a memory of the device. Upon receiving the request location signal, the device may retrieve the location of the vehicle and may provide the location of the vehicle to the call center. Similarly, the portable device may include a navigation system which communicates with a GPS satellite. Upon receiving the request location signal, the device may determine a current location by communicating with the GPS satellite and may provide the current location to the call center. Alternatively, one or both of the portable device and the device within the vehicle may include a location determining component, which may scan for signals from WiFi access points, GPS satellites, and cellular towers, and may determine a respective current location based on a unique signature of each of the scanned signals, as previously discussed. In a variation of the alternative embodiment, the portable device and/or the device within the vehicle may provide information, via a network, regarding each of the scanned signals to a remote processing device, such as, for example, a server, or other processing device, which may further determine a location based on a unique signature of each of the scanned signals.

The obtained location of the portable device and the obtained location of the vehicle may then be used to determine walking directions from the location of the portable device to the location of the vehicle (act 616). In embodiments in which the portable device includes a navigation system, the navigation system may determine the walking directions. In embodiments which include a remote processing device, such as, for example, a server, or other processing device connected to a network, the remote processing device may be provided with the location of the portable device and the location of the vehicle, and may further determine the walking directions.

A walking distance and a direct distance between the location of the portable device and the location of the vehicle may then be determined (act 702; FIG. 7). In embodiments in which the portable device determines the walking directions, the portable device may determine the walking distance based on the walking directions. In embodiments in which the remote processing device determines the walking directions, the remote processing device may determine the walking distance based on the walking directions.

A determination may then be made regarding whether the walking distance is less than or equal to a predetermined distance (act 704). The predetermined distance may be 100 feet, 75 feet, or another distance. The determination may be made by a same component that determines the walking directions.

If the walking distance or the direct distance is determined to be less than or equal to the predetermined distance, then a signal may be sent automatically to the device within the vehicle to cause the device to provide a near indication, which may include, but not be limited to, the audio indication and/or the visual indication from the vehicle (act 706).

If, during act 704, the walking distance and the direct distance are determined to be not less than or equal to the predetermined distance, or during act 706, the near indication has been provided, then the walking directions may be provided to the user via the portable device (act 708). The walking directions may be provided as text, and/or in graphical form, such as, for example, a map, which may be presented via a display of the portable device. Alternatively, the walking directions may be provided as generated speech via a speaker of the portable device. Act 612 (FIG. 6) may again be performed to determine whether the user is continuing to request walking directions. If the user no longer requests walking directions, then the main menu may again be presented to the user (act 602). Otherwise, acts 614-704 (FIG. 7) may again be performed to obtain the location of the portable device and the location of the vehicle, determine walking directions, determine a direct distance and a walking distance, and determine whether the walking distance or the direct distance is less than or equal to the predetermined distance.

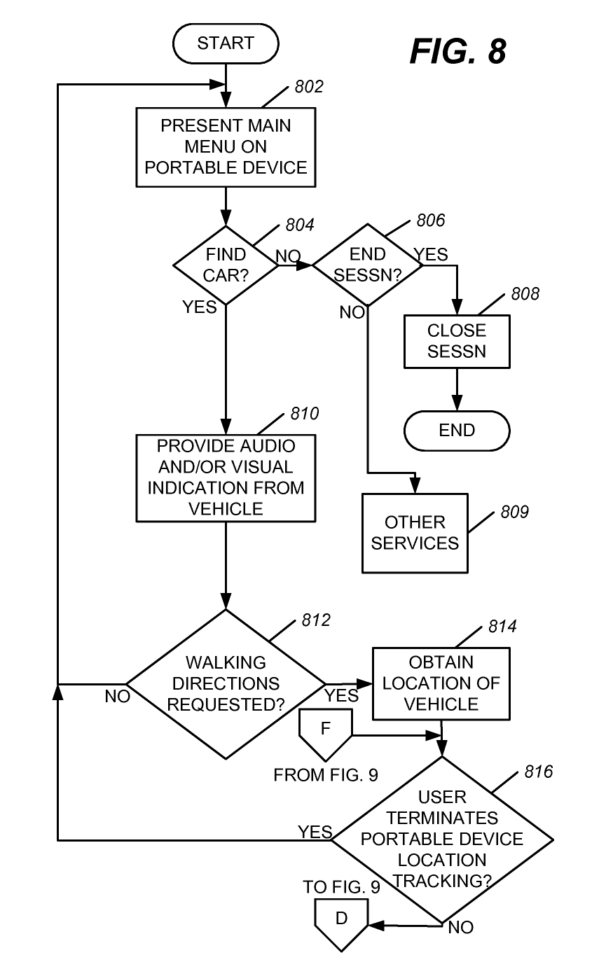

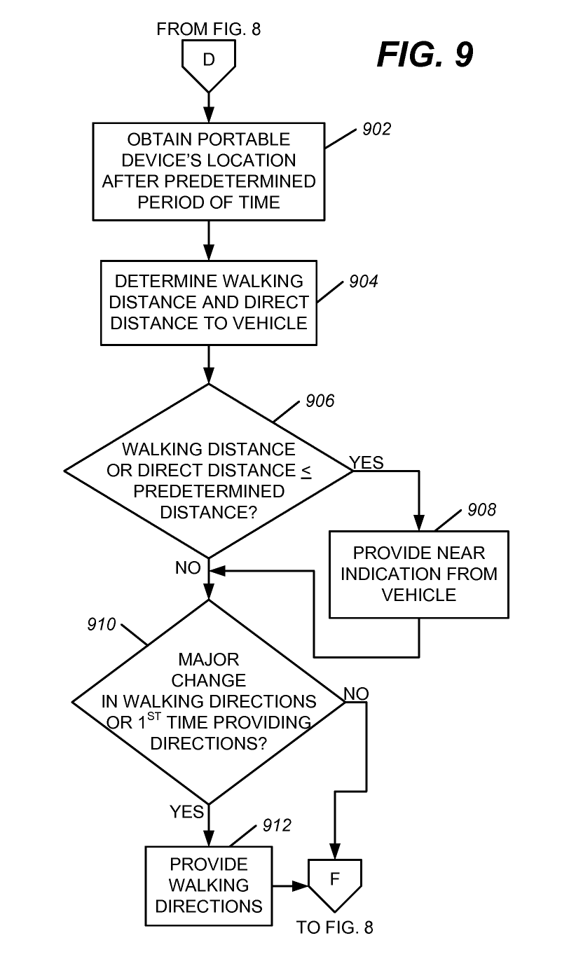

FIGS. 8 and 9 are flowcharts illustrating an exemplary process which may be performed in other embodiments. The process may begin with a main menu being presented on a display of a portable device (act 802). As previously mentioned with respect to FIGS. 6 and 7, the portable device may include a cellular phone which a user may use to call a call center. In such embodiments, after calling the call center via the portable device, and after the user is authenticated, the main menu may be presented on the display of the portable device. Alternatively, the main menu may be provided verbally, as generated speech, to the user via a speaker of the portable device. The portable device may include a cellular phone which further includes the speaker. The main menu may include a number of services that the user may select, including a “find car” service for helping the user find a parked vehicle.

Next, a determination may be made regarding whether the user has selected a “find car” service (act 804). As previously mentioned, the user may select a service by speaking a command into a microphone of the portable device, tapping a representation of the service on a touch screen display of the portable device, pressing a hard button or touching a soft button of the portable device, or via other selection methods.

If the user does not select the “find car” service, then a determination may be made regarding whether the user indicated a desire to end a current session (act 806). If the user indicated a desire to end the current session, then the session may be ended (act 808) and the process may be completed.

If, during act 806, a determination is made that the user did not indicate a desire to end the current session, then an assumption may be made that the user selected a service other than the “find car” service and the other service may be provided to the user (act 809).

If, during act 804, a determination is made that the user selected the “find car” service, then an audio indication and/or a visual indication may be provided from the vehicle for a preset period of time (act 810), such as, for example, 10 seconds or another period of time. In embodiments including a call center, a signal may be sent from the call center, via a network, to a device within the vehicle. Upon receiving the signal, the device may cause the audio indication and/or the visual indication to be provided. In other embodiments, the portable device may send the signal, via a network, to the device within the vehicle.

Next, a determination may be made regarding whether the user requests walking directions to the vehicle (act 812). The user may request walking directions by selecting a “request walking directions” menu item from a displayed menu, by pressing a hard button or touching a soft button, by speaking a command into a microphone of a cellular phone included in the portable device, or by other methods.

A location of the vehicle may then be obtained (act 814). In embodiments which include a call center, a request location signal may be sent to the device within the vehicle. The device within the vehicle may include a navigation system, which communicates with a GPS satellite. The navigation system may have tracked the location of the vehicle, until the vehicle is parked, and may have stored the location of the vehicle in a memory of the device. Upon receiving the request location signal, the device may retrieve the location of the vehicle and may provide the location of the vehicle to the call center. Alternatively, the device within the vehicle may include a location determining component, which may scan for signals from WiFi access points, GPS satellites, and cellular towers, and may determine a current location based on a unique signature of each of the scanned signals, as previously discussed. In a variation of the alternative embodiment, the device within the vehicle may provide information regarding each of the scanned signals to a remote processing device, such as, for example, a server, or other processing device, which may further determine a location based on a unique signature of each of the scanned signals.

Next, a determination may be made regarding whether the user has withdrawn or terminated authorization for tracking a current location of the portable device (act 816). If the user has withdrawn or terminated authorization for tracking the current location of the portable device, then acts 802 through 812 may again be performed. Otherwise, after a predetermined period of time, such as, for example, 3 seconds or another period of time, a current location of the portable device may be obtained (act 902; FIG. 9). As previously discussed, the portable device may include a navigation system which may communicate with a GPS satellite. Upon receiving a request location signal, the portable device may determine a current location. If the embodiment includes a call center, the portable device may send the current location to the call center. Alternatively, the portable device may include a location determining component, which may scan for signals from WiFi access points, GPS satellites, and cellular towers and may determine a current location based on a unique signature of each of the scanned signals. Alternatively, the portable device may provide information regarding each of the scanned signals to a remote processing device, such as, for example, a server, or other processing device, which may further determine a location based on a unique signature of each of the scanned signals.

The obtained location of the portable device and the obtained location of the device within the vehicle may then be used to determine a walking distance and a direct distance from the location of the portable device to the location of the vehicle (act 904). In embodiments in which the portable device may include a navigation system, the portable device may determine the walking distance and the direct distance. In other embodiments, a remote processing device, such as, for example, a server or other processing device connected to a network may be provided with the location of the portable device and the location of the vehicle, and may determine the walking distance and the direct distance.

In embodiments in which the portable device determines walking directions, the portable device may determine the walking distance based on the walking directions. In other embodiments in which the remote processing device determines the walking directions, the remote processing device may determine the walking distance based on the walking directions.

A determination may then be made regarding whether the walking distance or the direct distance is less than or equal to a predetermined distance (act 906). The predetermined distance may be 100 feet, 75 feet, or another distance. The determination may be made by a same component that determines the walking directions.

If, during act 906, the walking distance or the direct distance are determined to be less than or equal to the predetermined distance, then a signal may be sent automatically to the device within the vehicle to cause the device to provide a near indication, which may include the audio indication and/or the visual indication from the vehicle (act 908).

If, during act 906, the walking distance and the direct distance are determined to be greater than the predetermined distance, or, after act 908 is executed, a determination may be made regarding whether a major change in walking directions occur or whether this is a first time the walking directions are provided (act 910). In some embodiments, a major change in the walking directions may occur when a change of a current location of the portable device indicates that the user strayed from the walking directions.

If no major change in the walking directions is determined, then act 816 (FIG. 8) may be performed to determine whether the user continues to provide permission for obtaining a new current location of the portable device. Otherwise, the walking directions may be provided to the user via the portable device (act 912). The walking directions may be displayed as text and/or as a map on a display of the portable device. Alternatively, the walking directions may be provided as generated speech via a speaker of the portable device. Act 816 (FIG. 8) may again be performed to determine whether the user continues to provide permission for obtaining a new current location of the portable device. If the user continues to provide the permission, then acts 902-912 may be performed again. Therefore, as long as the user continues to provide permission for obtaining a location of the portable device, the location of the portable device may be tracked and the user may be provided with updated directions until the user carrying the portable device reaches a vicinity of the vehicle.

### CONCLUSION

Although the subject matter has been described in language specific to structural features and/or methodological acts, it is to be understood that the subject matter in the appended claims is not necessarily limited to the specific features or acts described above. Rather, the specific features and acts described above are disclosed as example forms for implementing the claims.

Although the above descriptions may contain specific details, they are not to be construed as limiting the claims in any way. Other configurations of the described embodiments are part of the scope of this disclosure. For example, other methods may be employed to determine a location of the vehicle or a location of the portable device. Further, in other embodiments, other devices or components may perform portions of the acts described above. Accordingly, the appended claims and their legal equivalents define the invention, rather than any specific examples given.

I claim as my invention:

1. A method for finding a vehicle, the method comprising:
receiving a request for finding the vehicle from a portable device located outside of the vehicle;
obtaining a location of the vehicle and a location of the portable device;
determining walking directions from the location of the portable device to the location of the vehicle;
determining a walking distance between the location of the vehicle and the location of the portable device based on the walking directions;
determining whether the walking distance is not greater than a predetermined distance; and
automatically providing an audio indication or a visual indication from the vehicle when the walking distance is determined to be less than or equal to the predetermined distance.

2. The method of claim 1, further comprising:
displaying the walking directions on a display of the portable device.

3. The method of claim 2, wherein the walking directions include a map indicating a route to the vehicle.

4. The method of claim 2, wherein the walking directions include text describing a route to the vehicle.

5. The method of claim 2, further comprising:
periodically obtaining a location of the portable device;
determining whether to update the walking directions based, at least partially, on a latest obtained location of the portable device; and
displaying updated walking directions on the portable device.

6. The method of claim 5, wherein:
a remote processing device performs the periodic obtaining of a location of the portable device, the determining of whether to update the walking directions, and providing of updated walking directions to the portable device for displaying.

7. The method of claim 5, wherein the portable device performs:
the periodic obtaining of a location of the portable device, and the determining of whether to update the walking directions.

8. The method of claim 5, wherein the determining of whether to update the walking directions further comprises:
determining a change in location of the portable device based on a latest obtained location of the portable device, and
determining that the walking directions are to be updated when the determined change in location indicates that a user carrying the portable device strayed from the walking directions.

9. A processing device comprising:
at least one processor; and
a memory connected to the processor, the memory further comprising:
instructions for obtaining a first location of a portable device located outside of a vehicle,
instructions for obtaining a second location of the vehicle,
instructions for determining a walking distance from the portable device to the vehicle based on the obtained first location and the obtained second location, and
instructions for sending a signal to a device within the vehicle to cause a visual indication or an audio indication to be provided from the vehicle when the determined walking distance is less than or equal to a predetermined walking distance.

10. The processing device of claim 9, wherein the instructions for determining a walking distance from the portable device to the vehicle further comprise:
instructions for determining walking directions from the obtained first location to the obtained second location, and
instructions for determining the walking distance based on the walking directions.

11. The processing device of claim 10, wherein the memory further comprises:
instructions for providing the walking directions for display on the portable device.

12. The processing device of claim 11, wherein the walking directions include a map indicating a route to the vehicle.

13. The processing device of claim 11, wherein the walking directions include text describing a route to the vehicle.

14. The processing device of claim 9, wherein the memory further comprises:
instructions for periodically obtaining a current first location of the portable device,
instructions for determining new walking directions based on a latest obtained current first location and the obtained second location,
instructions for determining whether a major change in the walking directions occurs based on the latest obtained first location, and
instructions for providing the new walking directions for display on the portable device when the major change is determined to occur.

15. The processing device of claim 9, wherein the processing device includes a server remotely located from the portable device and the vehicle.

16. The processing device of claim 9, wherein the processing device includes the portable device.

17. A method for finding a parked vehicle, the method comprising:
initiating, by a user from a portable device, a request to find the parked motor vehicle;
obtaining a first location of the parked vehicle and a second location of the portable device;
determining walking directions to the parked vehicle based on the first location and the second location;
determining a walking distance between the portable device and the parked vehicle;
automatically providing a near indication to the user when the walking distance is not greater than a predetermined distance; and
providing the walking directions to the portable device for presentation when the walking distance is determined to be greater than the predetermined distance.

18. The method of claim 17, wherein the near indication includes at least one of an audio indication or a visual indication from the parked vehicle.

19. The method of claim 17, further comprising:
periodically obtaining a current second location of the portable device;
determining new walking directions to the vehicle based on the first location information and the current second location information; and
presenting the new walking directions to the user via the portable device.

20. The method of claim 17, wherein the second location is obtained only with permission of the user.
